(19) United States
(12) Patent Application Publication
(10) Pub. No.: US 2023/0066783 A1
(43) Pub. Date: Mar. 2, 2023

(54) EMI FILTER DEVICE

(71) Applicant: MANDO CORPORATION, Gyeonggi-do (KR)

(72) Inventors: Nam Gyun KIM, Gyeonggi-do (KR); Su-Min LEE, Gyeonggi-do (KR)

(21) Appl. No.: 17/901,636

(22) Filed: Sep. 1, 2022

(30) Foreign Application Priority Data
Sep. 2, 2021 (KR) 10-2021-0116893

(51) Int. Cl. H01F 17/06; H01F 17/00

(52) U.S. Cl. CPC H01F 17/06; H01F 17/0013; H01F 2017/0093; H01F 2017/065

(57) ABSTRACT

The embodiments of the present disclosure relate to an EMI filter device. Specifically, an EMI filter device according to the present disclosure may include a signal processor configured to output a predetermined signal and output a noise source generated in a circuit, and a coil device for removing the noise source, wherein the coil device comprises a common mode coil including a first coil and a second coil on one core, wherein the first coil and the second coil are electrically connected to each other.

### CROSS REFERENCE TO RELATED APPLICATION

This application claims priority from Korean Patent Application No. 10-2021-0116893, filed on Sep. 2, 2021, which is hereby incorporated by reference for all purposes as if fully set forth herein.

### TECHNICAL FIELD

The embodiments of the present disclosure relate to an electro magnetic interference (EMI) filter device.

As switching technology is developed and applied to almost all power electronic devices, the technology of EMI (Electro Magnetic Interference) filtering is very important.

The conductive EMI component is divided into the common mode (CM) and differential mode (DM) components, and a passive filter may separate and filter the CM component and DM component, respectively. Most of the conductive noise components of electric/electronic devices operating as switching devices such as a switching mode power supply (SMPS) may appear in the shape of a square wave and may be composed of harmonic components of a switching frequency.

The conventional active EMI filter may use a method of using a CM filter and a DM filter separately and in series to remove the noise of the CM component and the DM component. Accordingly, there may be a problem in that the weight and volume of the EMI filer are increased, and electrical characteristics are deteriorated.

### SUMMARY

In this background, The present disclosure may provide an EMI filter device that removes differential mode choke noise using a common mode coil.

In an aspect of the present disclosure, there is provided an EMI filter device including a signal processor configured to output a predetermined signal and output a noise source generated in a circuit, and a coil device for removing the noise source, wherein the coil device comprises a common mode coil including a first coil and a second coil on one core, and wherein the first coil and the second coil are electrically connected to each other.

According to embodiments of the present disclosure, the EMI filter device may use a single coil for common mode noise and differential mode noise, thereby realizing device commonality, thereby reducing cost and maximizing device performance.

### BRIEF DESCRIPTION OF THE DRAWINGS

FIGS. 1A and 1B are diagrams for explaining a method for reducing general common mode noise and differential mode noise.

FIG. 2 is a block diagram illustrating an EMI filter device according to an embodiment of the present disclosure.

FIG. 3 is a circuit diagram illustrating an EMI filter device according to an embodiment of the present disclosure.

FIGS. 4A and 4B are diagrams for explaining that a first coil and a second coil are electrically connected according to an exemplary embodiment.

FIG. 5 is a diagram for explaining that a first coil and a second coil are implemented on a substrate according to an embodiment.

FIG. 6 is a diagram for explaining that a first coil and a second coil are implemented on a multilayer printed circuit board according to an embodiment.

### DETAILED DESCRIPTION

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the present disclosure, detailed descriptions of well-known functions and components incorporated herein will be omitted when it is determined that the description may make the subject matter in some embodiments of the present disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

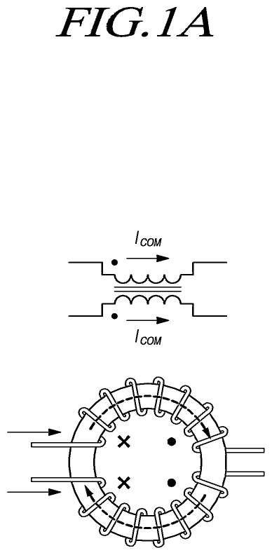

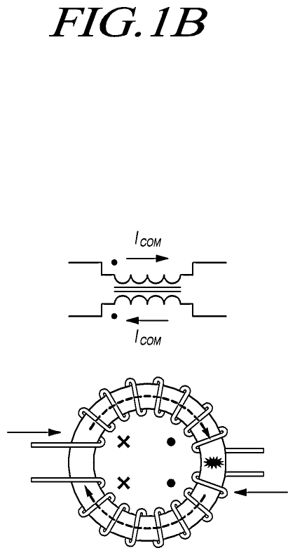

FIGS. 1A and 1B are diagrams for explaining a method for reducing general common mode noise and differential mode noise.

Referring to FIGS. 1A and 1B, the conductive noise and radiated noise are generated in a power module or control module included in an automotive electrical system and a general home appliances. This generated noise may cause interference with other electronic devices, resulting in significant disturbance or degradation of device performance. Accordingly, in order to reduce or remove this noise, noise may be divided into a common mode and a differential mode according to a phase, and each of the noises may be solved by a different method.

A common mode coil of FIG. 1A generates a magnetic field of the same magnitude and the same phase while the common-mode current flows in the same direction, and accordingly, since the common mode coil may have a high resistance to the common-mode signal, the common mode coil may suppress by attenuating the flow of the common-mode signal.

Conversely, in the differential mode coil of FIG. 1B, differential mode signals flow in opposite directions through the differential mode coil windings, so that magnetic fields of the same magnitude and opposite polarity are created and cancel each other out. Therefore, since the differential mode coil may have a resistance close to zero with respect to the differential mode signal, so that the differential mode coil may pass the signal without attenuation.

However, in order to reduce both common-mode noise and differential-mode noise, the size or number of each coil is required to be increased or the number of coils is required to be increased. In this case, the size and price of the EMI filter may increase.

Hereinafter, an EMI filter device 10 according to an embodiment of the present disclosure, which is used in parallel to remove common-mode noise and differential-mode noise with one coil, will be described with reference to the accompanying drawings.

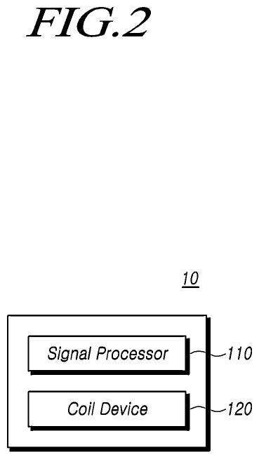

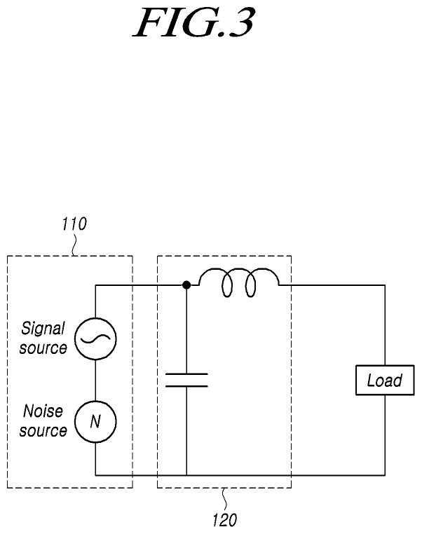

FIG. 2 is a block diagram illustrating an EMI filter device 10 according to an embodiment of the present disclosure, and FIG. 3 is a circuit diagram illustrating an EMI filter device 10 according to an embodiment of the present disclosure.

Referring to FIG. 2, the EMI filter device 10 according to an embodiment of the present disclosure may include a signal processor 110 and a coil device 120.

The signal processor 110 may output a predetermined signal and may output a noise source generated in the circuit. To this end, the signal processor 110 may include a signal generator. In addition, the noise source may be generated from a battery that supplies power to the electronic device. Furthermore, the noise source may be noise included in a power supply in a situation where external power is supplied to both ends of the signal processor 110. As an example, the noise source may be conductive noise or radiated noise generated in an electronic device, such as a signal generator, rather than a specific device.

Referring to FIG. 3, the coil device 120 may be connected in series with the signal processor 110 to remove a noise source. The coil device 120 may include a common mode coil including a first coil 410 and a second coil 420, and the first coil 410 and the second coil 420 are may be electrically connected to each other. That is, the first coil 410 and the second coil 420 may function as one coil as shown in FIG. 3.

In one embodiment, a load may be connected in series with the first coil 410 and the second coil 420, and after the noise included in the power is removed by the above-described coil, the power may be delivered to the load.

In one embodiment, the core type used in the common mode coil may be any one of a toroidal type with high magnetic permeability, a UU type (UU-9.8, UU-10.5, etc.) ET type and UT type.

The first coil 410 and the second coil 420 may be in the form of windings wound around the core, respectively, but is not limited thereto, and at least one of the first coil 410 and the second coil 420 may have a structure passing through the core.

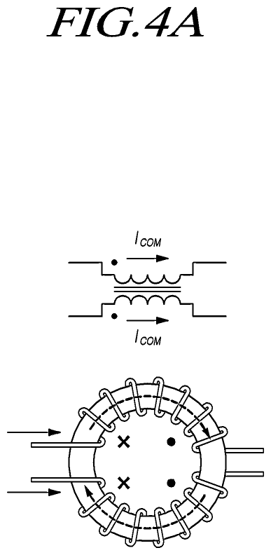

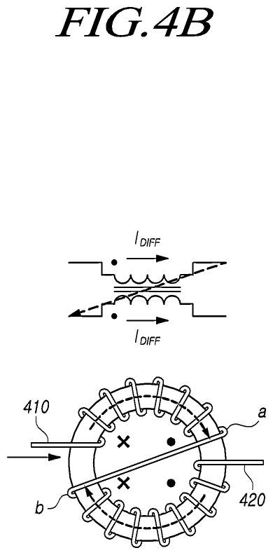

FIGS. 4A and 4B are diagrams for explaining that a first coil 410 and a second coil 420 are electrically connected according to an exemplary embodiment.

In an embodiment, the first coil 410 and the second coil 420 may be wound by one coil.

FIG. 4A illustrates a general common mode coil, and in the present disclosure, an EMI filter may be configured by changing the winding method of the common mode coil of FIG. 4A to that of FIG. 4B.

Referring to FIG. 4B, there may be wounded as one coil in which the point ‘a’ in FIG. 4 where the winding of the first coil 410 ends and the point ‘b’ in FIG. 4B where the winding of the second coil 420 starts are connected. In the case that the coil is wound by the above-described method, the coil has an effect of removing differential mode noise. In addition, the coil device may further include a capacitor X connected in parallel to the first coil 410 and the second coil 420 to remove the differential mode noise.

The above-described EMI filter device 10 may be implemented on a printed circuit board (PCB).

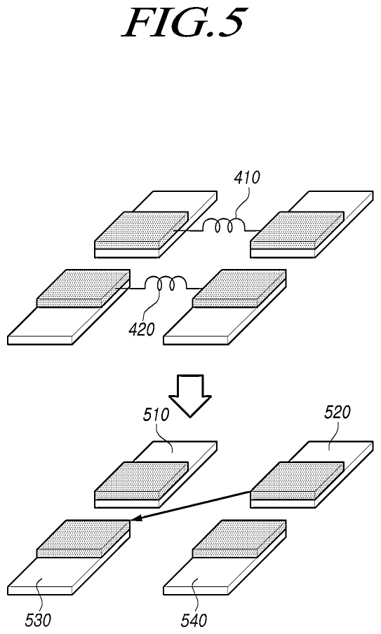

FIG. 5 is a diagram for explaining that a first coil 410 and a second coil 420 are implemented on a substrate according to an embodiment.

Referring to FIG. 5, the first coil 410 and the second coil 420 may be installed on substrates including a first surface 510 and a second surface 520 disposed to face each other, and a third surface 530 and a fourth surface 540 disposed to face each other, respectively. The first coil 410 may be installed on a substrate including the first surface 510 and the second surface 520 that are opposed to each other, and the second coil 420 may be installed on a substrate including the third surface 530 and the fourth surface 540 that are opposed to each other. In addition, the first coil 410 may be installed to connect the first surface 510 and the second surface 520, and the second coil 420 may be installed to connect the third surface 530 and the fourth surface 540.

In addition, in order to remove differential mode noise with a common mode coil, the second surface 520 and the third surface 530 may be electrically connected as shown in FIG. 5. Accordingly, in the printed circuit board, the current may flow while drawing a Z-shape in the order of the first surface 510, the second surface 520, the third surface 530 and the fourth surface 540. In addition, the first surface 510 and the second surface 520 may be located on an upper portion of the third surface 530 and the fourth surface 540.

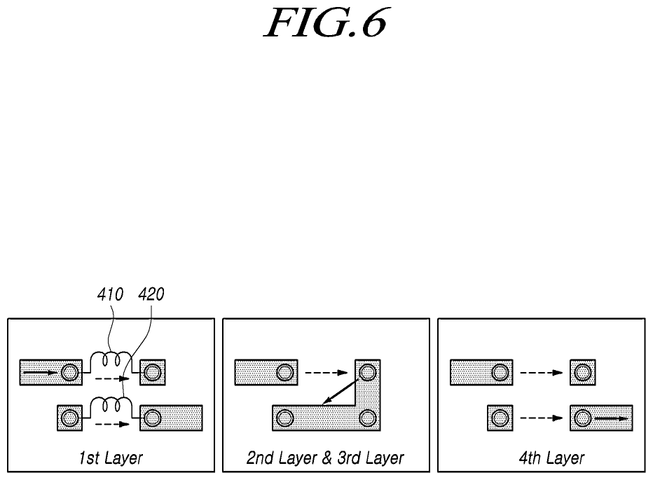

FIG. 6 is a diagram for explaining that a first coil 410 and a second coil 420 are implemented on a multilayer printed circuit board according to an embodiment.

Referring to FIG. 6, the EMI filter device 10 according to an embodiment of the present disclosure may be implemented in the above-described multilayer printed circuit board. For example, to explain the connection relationship between the first coil 410 and the second coil 420 with a printed circuit board composed of four layers, each coil may be installed in a PCB pattern printed on each layer and a hole formed on the PCB pattern.

The positions of the holes formed in each layer may be formed at the same position. That is, the position of the hole formed in the first layer may be the same as the position of the hole formed in the second layer.

Accordingly, as shown in FIG. 6, when the first coil 410 and the second coil 420 are connected, in the first and fourth layers, the first surface 510 and the second surface 520, and the third surface 530 and the fourth surface 540 may be connected to each other through the first coil 410 and the second coil 420, respectively.

In addition, in order to electrically connect the first coil 410 and the second coil 420, a PCB pattern may be formed in the second layer and the third layer as shown in FIG. 6. That is, in the second layer and the third layer, the second surface 520 and the third surface 530 may be electrically connected through a PCB pattern formed on the second surface 520 and the third surface 530. In one embodiment, the EMI filter device 10 may be implemented by a separate device for connecting the coil leads respectively exposed to the printed circuit board surface on which the common mode coil is installed. is not the first coil 410 and the second coil 420 are connected by a printed circuit board internal pattern, rather than a configuration in which the first coil 410 and the second coil 420 are connected by a printed circuit board internal pattern as in the above-described multi-layer printed circuit board.

As described above, the EMI filter device 10 may remove two types of noise with one type of choke coil.

In addition, when using the winding or turn of the general common-mode coil, as the following the equation 1, it is possible to secure a sufficient LDM value since the L value can be used as many times as the N-th number of windings.

$$L = \frac{{N}^{2}}{{R}_{m}} = \frac{μ {SN}^{2}}{l} ( L ∝ {N}^{2} ) \qquad [ Equation 1 ]$$

The above description has been presented to enable any person skilled in the art to make and use the technical idea of the present disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the present disclosure. The above description and the accompanying drawings provide an example of the technical idea of the present disclosure for illustrative purposes only. That is, the disclosed embodiments are intended to illustrate the scope of the technical idea of the present disclosure. Thus, the scope of the present disclosure is not limited to the embodiments shown, but is to be accorded the widest scope consistent with the claims. The scope of protection of the present disclosure should be construed based on the following claims, and all technical ideas within the scope of equivalents thereof should be construed as being included within the scope of the present disclosure.

What is claimed is:

1. An EMI filter device comprising:
a signal processor configured to output a predetermined signal and output a noise source generated in a circuit; and
a coil device for removing the noise source,
wherein the coil device comprises a common mode coil including a first coil and a second coil on one core,
wherein the first coil and the second coil are electrically connected to each other.

2. The EMI filter device of claim 1, wherein the first coil and the second coil are wound by one coil.

3. The EMI filter device of claim 1, wherein the coil device further comprises a capacitor X for removing differential mode noise.

4. The EMI filter device of claim 1, wherein the first coil is installed on a substrate including a first surface and a second surface that are opposed to each other, and the second coil is installed on a substrate including a third surface and a fourth surface that are opposed to each other,
wherein the first coil is installed to connect the first surface and the second surface, and the second coil is installed to connect the third surface and the fourth surface.

5. The EMI filter device of claim 4, wherein the first surface and the second surface are located on an upper portion of the third surface and the fourth surface, and the second surface is electrically connected to the third surface.

6. The EMI filter device of claim 4, wherein the substrate is a multilayer printed circuit board.

7. The EMI filter device of claim 6, wherein, in a first layer and a fourth layer, the first surface and the second surface are connected through the first coil and the third surface and the fourth surface are connected through the second coil,
wherein, in a second layer and a third layers, the second surface is electrically connected to the third surface.
